(19) United States
(12) Patent Application Publication
(10) Pub. No.: US 2026/0243295 A1
(43) Pub. Date: Aug. 20, 2026

(54) SELF-LOCKING FASTENER AND NUT

(71) Applicant: Randolph Allen Rogers, Palm Desert, CA (US)

(72) Inventor: Randolph Allen Rogers, Palm Desert, CA (US)

(21) Appl. No.: 19/536,133

(22) Filed: Feb. 10, 2026

Related U.S. Application Data
(60) Provisional application No. 63/760,506, filed on Feb. 19, 2025.

(51) Int. Cl. F16B 39/282; F16B 39/02; F16B 39/12; F16B 39/24; F16B 39/34

(52) U.S. Cl. CPC F16B 39/282; F16B 39/026; F16B 39/12; F16B 39/24; F16B 39/34

(57) ABSTRACT

A self-locking fastener includes a fastener head including a first side and a second side, and a threaded rod that extends from the second side of the fastener head. The self-locking fastener also includes a circular recess formed in a surface of the second side of the fastener head. A compressible helical extrusion is adapted to be positioned within the circular recess and spiral around the threaded rod. At least a portion of the compressible helical extrusion spirals outwardly beyond the surface of the second side of the fastener head.

### CROSS-REFERENCE TO RELATED APPLICATIONS

This application claims benefit of and priority to U.S. Provisional Application No. 63/760,506, filed on Feb. 19, 2025, and entitled SELF-LOCKING FASTENER AND NUT.

### TECHNICAL FIELD

This disclosure relates generally to fastening technologies, and more particularly, to a self-locking fastener, a self-locking nut, or both.

### BACKGROUND

Current fastening technologies, even those that purport to be “self-locking,” often employ multiple pieces to secure objects to one another, or cannot be reused easily. For instance, in some applications, conventional fastening technologies rely on handling small, separate locking pieces, such as a lock washer or a compression spring. However, such small pieces can be easily dropped, and even lost while attempting installation. This can be frustrating and time consuming for an installer, but also contaminate a product, object, or material being fastened.

Therefore, there is a need for improved fastening technologies.

### SUMMARY

According to some implementations of the present disclosure, a self-locking fastener includes a fastener head including a first side and a second side, and a threaded rod that extends from the second side of the fastener head. The self-locking fastener also includes a circular recess formed in a surface of the second side of the fastener head. A compressible helical extrusion is adapted to be positioned within the circular recess and spiral around the threaded rod. At least a portion of the compressible helical extrusion spirals outwardly beyond the surface of the second side of the fastener head.

According to some implementations of the present disclosure, the compressible helical extrusion is connected to the circular recess.

According to some implementations of the present disclosure, a cross-section of the compressible helical extrusion is rectangular, square, circular, or oval.

According to some implementations of the present disclosure, a center of the circular recess corresponds to the center of the threaded rod, and an outer diameter of a spiral formed by the compressible helical extrusion is less than a diameter of the circular recess of the fastener head.

According to some implementations of the present disclosure, at least a portion of the compressible helical extrusion comprises a pebbled finish, or a burred finish.

According to some implementations of the present disclosure, the fastener head and the compressible helical extrusion are formed using a carbon fiber material or an organic material.

According to some implementations of the present disclosure, a force applied to the compressible helical extrusion transforms the compressible helical extrusion into a compressed state in which the compressible helical extrusion fits entirely inside the circular recess.

According to some implementations of the present disclosure, the self-locking fastener further comprises a seal recess formed in a surface of the second side of the fastener head, the seal recess configured to receive a seal ring.

According to some implementations of the present disclosure, the self-locking fastener comprises a screw, a bolt, an anchor, a knob, or a plug.

According to some implementations of the present disclosure, a self-locking nut includes a nut body including a first side and a second side, and a threaded through-hole that extends from the first side of the nut body. The self-locking nut also includes a circular recess formed in a surface of the second side of the nut body. A compressible helical extrusion is adapted to be positioned within the circular recess and spiral around an extended perimeter of the threaded through-hole. At least a portion of the compressible helical extrusion spirals outwardly beyond the surface of the second side of the nut body.

According to some implementations of the present disclosure, the compressible helical extrusion is connected to the circular recess.

According to some implementations of the present disclosure, a cross-section of the compressible helical extrusion is rectangular, square, circular, or oval.

According to some implementations of the present disclosure, a center of the circular recess corresponds to the center of the threaded through-hole, and an outer diameter of a spiral formed by the compressible helical extrusion is less than a diameter of the circular recess of the nut body.

According to some implementations of the present disclosure, at least a portion of the compressible helical extrusion comprises a pebbled finish, or a burred finish.

According to some implementations of the present disclosure, the nut body and the compressible helical extrusion are formed using a carbon fiber material or an organic material.

According to some implementations of the present disclosure, a force applied to the compressible helical extrusion compacts the compressible helical extrusion into the circular recess.

According to some implementations of the present disclosure, the self-locking nut further comprises a seal recess formed in a surface of the second side of the fastener head, the seal recess configured to receive a seal ring.

According to some implementations of the present disclosure, the self-locking nut comprises a hex nut, a jam nut, a castle nut, a square nut, a cap nut, a slotted nut, a flanged nut, a wing nut, a coupling, or a knob.

According to some implementations of the present disclosure, a self-locking fastener includes a fastener body comprising a first side and a second side, and a threaded region that extends from the second side of the fastener body or through the fastener body. The self-locking fastener also includes a circular recess formed in a surface of the second side of the fastener body. A compressible helical extrusion is adapted to be positioned within the circular recess. An inner diameter of the compressible helical extrusion is greater than a diameter of the threaded region, and at least a portion of the compressible helical extrusion spirals outwardly beyond the surface of the second side of the fastener body.

According to some implementations of the present disclosure, the compressible helical extrusion is connected to the circular recess of the fastener body.

The above summary is not intended to represent each embodiment or every aspect of the present disclosure. Rather, the foregoing summary merely provides an example of some of the novel aspects and features set forth herein. The above features and advantages, and other features and advantages of the present disclosure, will be readily apparent from the following detailed description of representative embodiments and modes for carrying out the present invention, when taken in connection with the accompanying drawings and the appended claims.

### BRIEF DESCRIPTION OF THE DRAWINGS

The foregoing and other advantages of the present disclosure will become apparent upon reading the following detailed description and upon reference to the drawings.

FIG. 1 is a perspective view of an example self-locking fastener, according to aspects of the present disclosure.

FIG. 2A is a cross-sectional view of the example self-locking fastener shown in FIG. 1, according to aspects of the present disclosure.

FIG. 2B is a top view of the example self-locking fastener shown in FIG. 1, according to aspects of the present disclosure.

FIG. 3A illustrates an example application of the self-locking fastener shown in FIG. 1, according to aspects of the present disclosure.

FIG. 3B illustrates another example application of another example self-locking fastener, according to aspects of the present disclosure.

FIG. 4A is a perspective view of another example self-locking fastener, according to aspects of the present disclosure.

FIG. 4B is another perspective view of the example self-locking fastener shown in FIG. 4A, according to aspects of the present disclosure.

FIG. 4C is a side view of the example self-locking fastener shown in FIG. 4A, according to aspects of the present disclosure.

FIG. 5A is a perspective view of an example self-locking nut, according to aspects of the present disclosure.

FIG. 5B is a bottom view of the example self-locking nut shown in FIG. 5A, according to aspects of the present disclosure.

FIG. 5C is a side view of the example self-locking nut shown in FIG. 5A, according to aspects of the present disclosure.

FIG. 6A is a cross-sectional view of the example self-locking nut shown in FIG. 5A, according to aspects of the present disclosure.

FIG. 6B is a bottom view of the example self-locking nut shown in FIG. 6A, according to aspects of the present disclosure.

FIG. 7A illustrates an example application of the self-locking nut shown in FIG. 5A, according to aspects of the present disclosure.

FIG. 7B illustrates another example application of another example self-locking nut, according to aspects of the present disclosure.

FIG. 8 illustrates a cross-sectional view of another example of a self-locking fastener, according to aspects of the present disclosure.

FIG. 9 illustrates a cross-sectional view of another example of a self-locking nut, according to aspects of the present disclosure.

FIG. 10 illustrates a cross-sectional view of a further example of a self-locking fastener, according to aspects of the present disclosure.

FIG. 11 illustrates a cross-sectional view of a further example of a self-locking nut, according to aspects of the present disclosure.

While the present disclosure is susceptible to various modifications and alternative forms, specific implementations have been shown by way of example in the drawings and will be described in further detail herein. It should be understood, however, that the present disclosure is not intended to be limited to the particular forms disclosed. Rather, the present disclosure is to cover all modifications, equivalents, and alternatives falling within the spirit and scope of the present disclosure as defined by the appended claims.

### DETAILED DESCRIPTION

Many applications rely on an object being held to another object using a fastener. And while such objects may be secured together during installation, certain conditions such as movement, vibration, temperature variation, and so on, may introduce motion that could loosen such objects from one another. This can lead to unwanted object movement, costly maintenance or repair, object damage, and even dangerous situations, in some cases.

Conventional technologies attempt to address such problem with “self-locking” capabilities, which can involve using additional pieces to lock a fastener in place. For instance, some applications rely on a small, separate locking piece (e.g., a lock washer or compression spring) to lock a bolt into place. Yet such small locking piece can easily be dropped and even lost while attempting installation, which can lead to frustration, additional time for installation, as well as product or material contamination. Other applications utilize various locking nuts on conventional bolts or screws. Such locking nuts either use multiple pieces or locking mechanisms that become irreversibly deformed or deform objects being fastened upon installation, which can make it difficult or impossible to remove the locking nut, or to change or make adjustments to the material being fastened, or to reuse such “self-locking” nut.

Unlike conventional technologies, the present disclosure introduces a new fastening approach that incorporates a true, self-locking mechanism to secure one or more objects together. For instance, a compressible helical extrusion integrated into a self-locking fastener or self-locking nut, in accordance with embodiments described herein, may be utilized to removably secure an object to another.

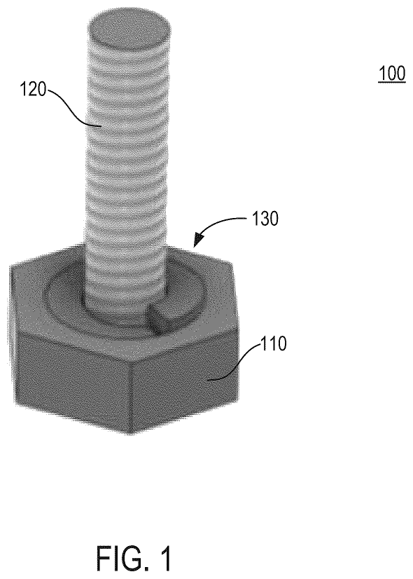

Turning to FIG. 1, an example self-locking fastener 100, in accordance with aspects of the present disclosure, is illustrated. In some embodiments, the self-locking fastener 100 includes a fastener body or head 110, and a threaded region, which in this embodiment is a threaded rod 120 that extends from the fastener head 100, as shown. The self-locking fastener 100 may also include an integrated locking mechanism 130 for securing the fastener head 110 in place. As appreciated from description herein, a self-locking fastener 100 with an integrated locking mechanism 130, according to embodiments described herein, may provide a number of advantages and improvements over conventional fastening technologies.

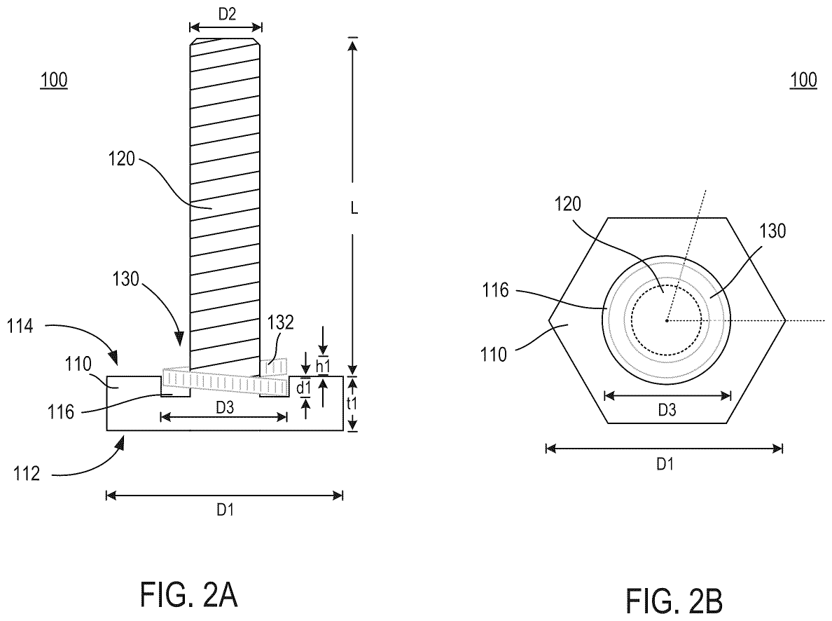

Referring specifically to FIGS. 2A-2C, in some embodiments, the self-locking fastener 100 may include a fastener head 110 having a first side 112 and a second side 114, where the fastener head 110 has a diameter D1 and thickness t1. The shape and/or dimension of the fastener head 110 may vary. A threaded rod 120 with diameter D2 and length L may extend from the second side 114 of the fastener head 110, as shown. The shape, dimension, and/or threading of the threaded rod 120 may vary. In some embodiments, the fastener body or head 110 may include a circular recess 116 formed in a surface of the second side 114 of the fastener body or head 110. In some embodiments, the circular recess 116 may have a diameter D3, and extend below the surface of the second side 114 of the fastener body or head 110 to a depth d1. The shape and/or dimension of the circular recess 116 may vary. As shown in FIG. 2B, the center of the circular recess 116 may correspond to the center of the threaded rod 120.

In some embodiments, the integrated locking mechanism 130 of the self-locking fastener 100 may include a compressible helical extrusion 132 (for example without limitation, a compression spring, a coil, a split-washer, a lock-washer and so forth) that extends from, and/or is connected to, the circular recess 116 in at least one point or a region of contact or attachment on the circular recess 116 (for example, bottom surface, sidewall, and so forth, of the circular recess 116). In an embodiment, the compressible helical extrusion 132 can be connected to the circular recess 116, for example, by being brazed, welded, or adhered in place. In other embodiments, the compressible helical extrusion 132 is integral with the circular recess 116, and/or is manufactured together with the fastener head 110.

The compressible helical extrusion 132 may spiral outwardly from the point(s) or region of contact or attachment, and in an uncompressed state extend to a height h1 above the surface of the second side 114 of the fastener head 110, as shown FIG. 2A. The shape, dimension, stiffness, and/or number of turns of the compressible helical extrusion 132 may vary.

In some embodiments, an outer diameter of a spiral formed by the compressible helical extrusion 132 may be approximately equal to, or less than, the diameter D3 of the circular recess 116, and less than the diameter D1 of the fastener head 110, as illustrated in FIG. 2A. In some embodiments, the compressible helical extrusion 132 may have a single outer diameter. In other embodiments, at least a portion of the compressible helical extrusion 132 may have a variable outer diameter. For example, the portion of the compressible helical extrusion 132 may have an outer diameter that decreases away from the point(s) or region of contact or attachment on the circular recess 116.

The shape of the cross-section of the compressible helical extrusion 132 may vary at one or more points along the spiral. For instance, the cross-section of the compressible helical extrusion 132 may have a shape that is rectangular, square, circular, oval, irregular, and so forth, and any combination thereof. In some embodiments, at least a portion of the compressible helical extrusion 132 may include a pebbled finish, a burred finish, a textured finish, a smooth finish, and so forth, or a combination thereof. The pebbled, burred, or textured finish can increase frictional resistance between the compressible helical extrusion and the immediately adjacent surface to enhance the “locking” of the fastener into place.

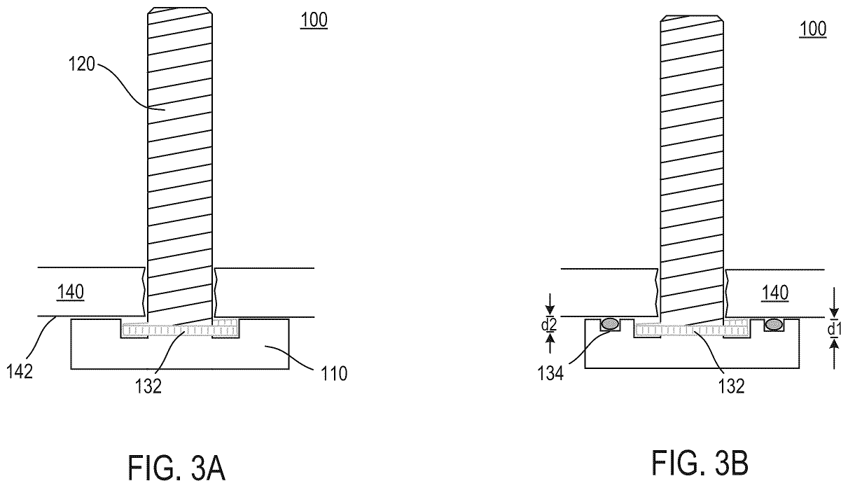

When a force is applied to the compressible helical extrusion 132, the compressible helical extrusion 132 may transform into a compressed state. For instance, a force may be applied by a fastening receptacle 140 to which the self-locking fastener 100 may be attached, as illustrated in the example of FIG. 3A. In some embodiments, the circular recess 116 and/or compressible helical extrusion 132 may be configured so that the compressible helical extrusion 132 fits entirely inside the circular recess 116 when the compressible helical extrusion 132 is in the compressed state, as shown. For example, stiffness, number of turns, material, dimensionality, shape, or a combination thereof, of the compressible helical extrusion 132 may be selected to respond to an applied force in a manner that transforms the compressible helical extrusion 132 into a compressed state that fits inside, or substantially corresponds to the shape and dimension of the circular recess 116. Such configuration may be advantageous in some applications, whereby the surface of the second side 114 of the fastener head 110 may be brought in proximity to (e.g., less than 1 mm) or flush with (e.g., direct contact) a surface 142 of the fastening receptacle 140.

For example, as illustrated in FIG. 3A, the self-locking fastener 100 may be bolted or screwed into a threaded opening of the fastening receptacle 140. Compression of the compressible helical extrusion 132 by the surface 142 of the fastening receptacle 140 can create resistance between the compressible helical extrusion 132 and the surface 142 of the fastening receptacle 140, as well as between threads of the threaded rod 120 and threaded opening of the fastening receptacle 140, which may help prevent the self-locking fastener 100 from loosening due to vibrations or other mechanical movement.

In some embodiments, the self-locking fastener 100 may include features or capabilities for sealing the self-locking fastener 100 to the fastening receptacle 142. For instance, in some embodiments, the fastener head 110 may include a seal recess 134 (e.g., an annular channel) formed in the surface of the second side 114 of the fastener head 110, as shown in FIG. 3B. The seal recess 134 extends below the surface of the second side 114 to a depth d2. In some embodiments, the seal recess 134 may be configured to receive a sealing element or sealant (e.g., an O-ring, a washer, a seal ring, an adhesive, a lubricant, and so forth). The sealing element or sealant may include various deformable and/or non-deformable materials, such as elastomer, metal, polyurethane, and so forth.

The self-locking fastener 100, or components thereof, may be manufactured using various materials. For example, self-locking fastener 100, or components thereof, may include metal, plastic, carbon fiber, elastomer, organic, and other materials, or any combination thereof.

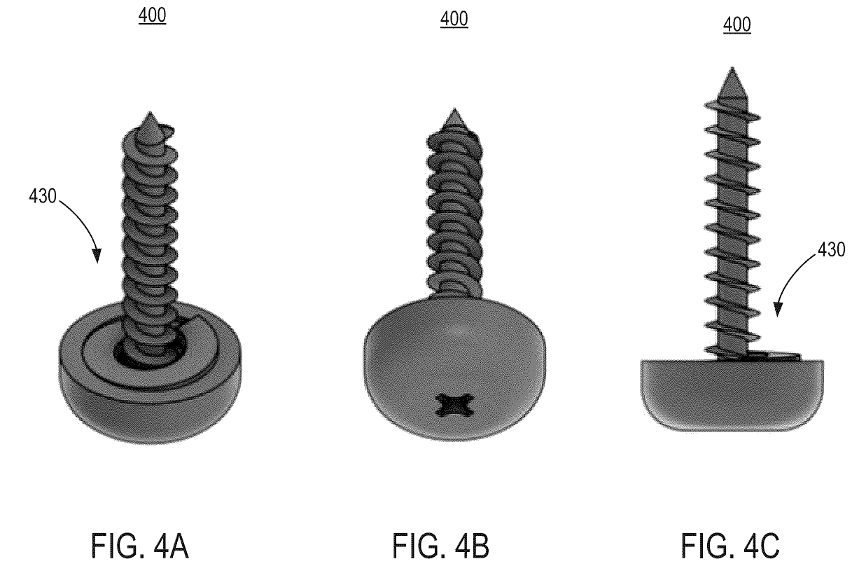

While the self-locking fastener 100 shown and described with reference to FIGS. 1, 2A-2B, and 3A-3B illustrate a hexagonal bolt as an example, the self-locking fastener 100 is not so limited. For instance, FIGS. 4A-4C illustrate another non-limiting example, whereby a self-locking fastener 400 is a round-head screw that incorporates an integrated locking mechanism 430, as described above. Furthermore, in other non-limiting examples, a self-locking fastener may include an anchor, a knob, a plug, and so forth.

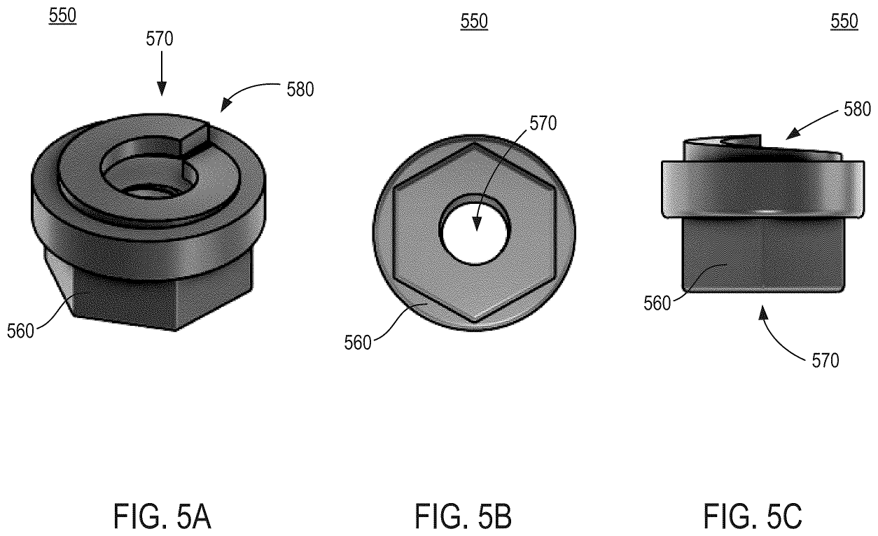

Turning now to FIGS. 5A-5C, an example self-locking nut 550, in accordance with aspects of the present disclosure, is illustrated. In some embodiments, the self-locking nut 550 may include a fastener or nut body 560, with a threaded region, which in this embodiment is a threaded through-hole 570 that traverses the fastener or nut body 560, as shown. The self-locking nut 550 may also include an integrated locking mechanism 580 for securing the self-locking nut 550 in place. As appreciated from description herein, a self-locking nut 550 with an integrated locking mechanism 580, according to embodiments describes herein, may provide a number of advantages and improvements over conventional fastening technologies.

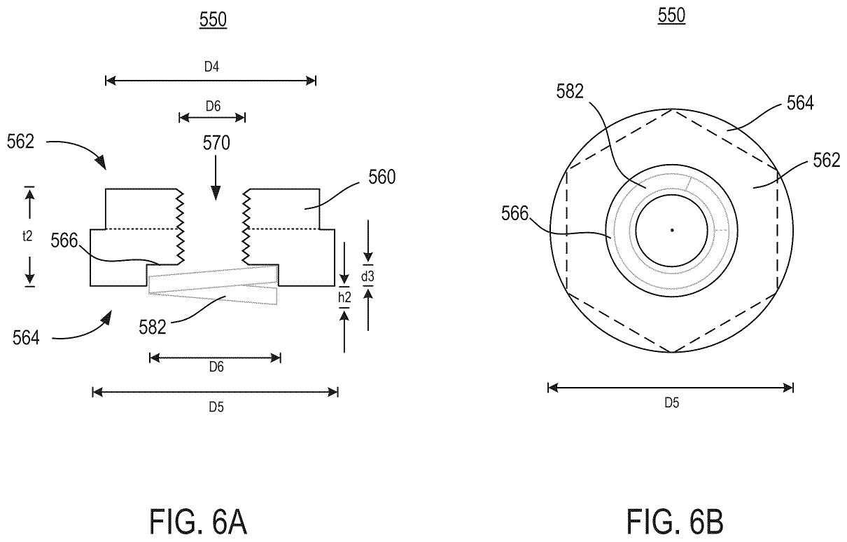

Referring specifically to FIGS. 6A-6B, an example self-locking nut 550, according to aspects of the present disclosure, is illustrated. In some embodiments, the nut body 560 may include a first body portion 562 with a diameter D4 on a first side of the nut body 560, and a second body portion 564 with a diameter D5 on the second side of the nut body 560, with the nut body 560 having a thickness t2. As illustrated in FIG. 6B, in some embodiments, the first body portion 562 may be hexagonal (e.g., for engaging a wrench, a socket, and so forth), but the shape and/or dimension of the nut body 560, and portions thereof, may vary. The nut body 560 may include a threaded through-hole 570 that extends from a first side of the nut body 560 through the nut body 560, as shown. The shape, dimension, and/or threading of the threaded through-hole 560 may vary.

In some embodiments, the nut body 560 may include a circular recess 566 formed in a surface of the second side 114 of the nut body 560. In some embodiments, the circular recess 566 may have a nominal diameter D6, and extend below the surface of the second side of the nut body 560 to a depth d3, as shown in FIG. 6A. The shape and/or dimension of the circular recess 566 may vary. The center of the circular recess 566 may correspond to the center of the threaded through-hole 570, as shown in FIG. 6B.

In some embodiments, the integrated locking mechanism 580 of the self-locking nut 550 may include a compressible helical extrusion 582 (for example without limitation, a compression spring, a coil, a split-washer, a lock-washer and so forth) that extends from, and/or is connected to, the circular recess 566 in at least one point or a region of contact or attachment on the circular recess 566 (for example, bottom surface, sidewall, and so forth, of the circular recess 566). In an embodiment, the compressible helical extrusion 582 can be connected to the circular recess 566, for example, by being brazed, welded, or adhered in place. In other embodiments, the compressible helical extrusion 582 is integral with the circular recess 566, and/or is manufactured together with the nut body 560.

The compressible helical extrusion 582 may spiral outwardly from the point(s) or region of contact or attachment, and in an uncompressed state extend to a height h2 above the surface of the second side of the nut body 560, as shown FIG. 6A. The shape, dimension, stiffness, and/or number of turns of the compressible helical extrusion 582 may vary.

In some embodiments, an outer diameter of a spiral formed by the compressible helical extrusion 582 may be approximately equal to, or less than, the diameter D6 of the circular recess 566, and less than the diameter D5 of the second body portion 564, as illustrated in FIG. 6A. In some embodiments, the compressible helical extrusion 582 may have a single outer diameter. In other embodiments, at least a portion of the compressible helical extrusion 582 may have a variable outer diameter. For example, the portion of the compressible helical extrusion 582 may have an outer diameter that decreases away from the point(s) or region of contact or attachment on the circular recess 566.

The shape of the cross-section of the compressible helical extrusion 582 may vary at one or more points along the spiral. For instance, the cross-section of the compressible helical extrusion 582 may have a shape that is rectangular, square, circular, oval, irregular, and so forth, and any combination thereof. In some embodiments, at least a portion of the compressible helical extrusion 582 may include a pebbled finish, a burred finish, a textured finish, a smooth finish, and so forth, or a combination thereof.

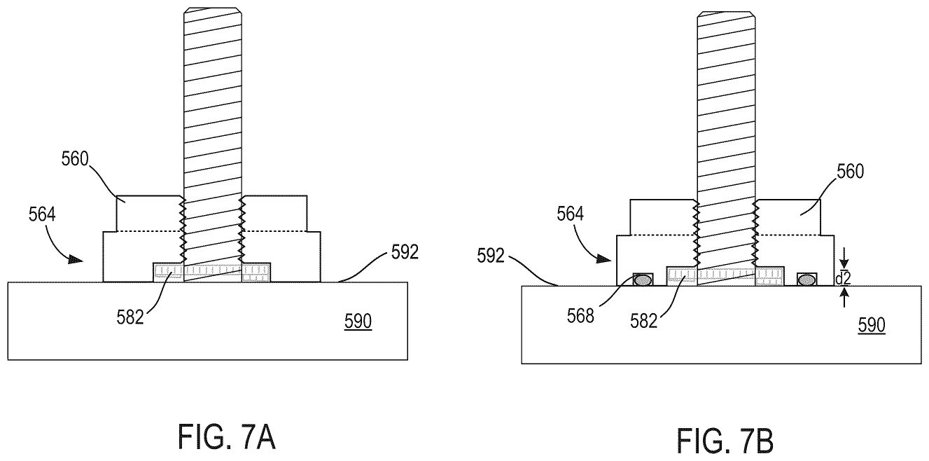

When a force is applied to the compressible helical extrusion 582, the compressible helical extrusion 582 may transform into a compressed state. For instance, a force may be applied by a fastening receptacle 590 to which the self-locking nut 550 may be attached, as illustrated in the example of FIG. 7. In some embodiments, the circular recess 566 and/or compressible helical extrusion 582 may be configured so that the compressible helical extrusion 582 fits entirely inside the circular recess 566 when the compressible helical extrusion 582 is in the compressed state, as shown. For example, stiffness, number of turns, material, dimensionality, shape, or a combination thereof, of the compressible helical extrusion 582 may be selected to respond to an applied force in a manner that transforms the compressible helical extrusion 582 into a compressed state that fits inside, or substantially corresponds to the shape and dimension of the circular recess 566. Such configuration may be advantageous in some applications, whereby the surface of the second nut portion 564 may be brought in proximity to (e.g., less than 1 mm) or flush with (e.g., direct contact) a surface 592 of the fastening receptacle 590.

In some embodiments, the self-locking nut 550 may include features or capabilities for sealing the self-locking nut 550 to the fastening receptacle 590. For instance, in some embodiments, the second nut portion 564 may include a seal recess 568 (e.g., an annular channel) formed in the surface of the second nut portion 564 of the nut body 560. The seal recess 568 may extend below the surface of the second nut portion 564 of the nut body 560 to a depth d4. In some embodiments, the seal recess 568 may be configured to receive a sealing element or sealant (e.g., an O-ring, a washer, a seal ring, an adhesive, a lubricant, and so forth). The sealing element or sealant may include various deformable and/or non-deformable materials, such as elastomer, metal, polyurethane, and so forth.

The self-locking nut 550, or components thereof, may be manufactured using various materials. For example, self-locking nut 550, or components thereof, may include metal, plastic, carbon fiber, elastomer, organic, and other materials, or any combination thereof. While the self-locking nut 550 shown and described with reference to FIGS. 5A-5C, 6A-6B, and 7A-7B illustrate a hexagonal nut as an example, the self-locking nut 550 is not so limited. For instance, in other non-limiting examples, a self-locking nut may be a jam nut, a castle nut, a square nut, a cap nut, a slotted nut, a flanged nut, a wing nut, a coupling, or a knob.

As appreciated from description herein, the present approach provides a number of advances over conventional technologies. For instance, unlike traditional split-washers, an integrated locking mechanism, as described herein, may be configured to remain cleanly hidden and protected by either a faster head or nut body, resulting in a smooth finish without edges that can catch or become soiled. Such design may also prevent an integrated locking mechanism from splaying out over time and use.

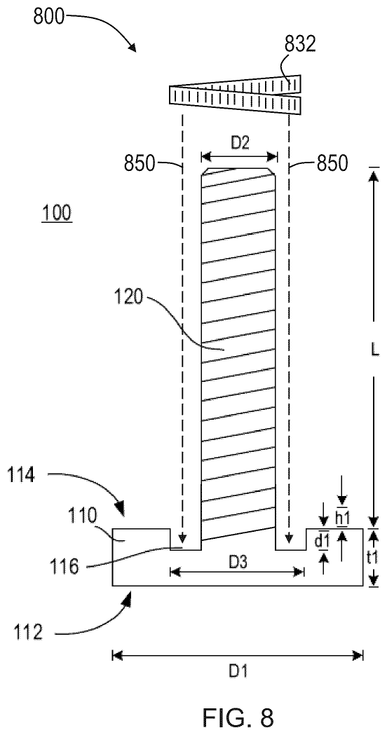

In some embodiments, the above-described self-locking fastener, and/or self-locking nut may be a two-piece unit with hidden and protected locking mechanism. For instance, referring to FIG. 8, in an embodiment a self-locking fastener 800 includes the fastener body or head 110 including the recess 116 and the threaded rod 120, and also includes a separate compressible helical extrusion 832. The separate compressible helical extrusion 832 can be a circular locking mechanism 832, for example without limitation, a traditional lock washer or a compression spring or of a hybrid of the two, which is engineered to precisely fit within the circular recess 116, as indicated by dashed arrows 850.

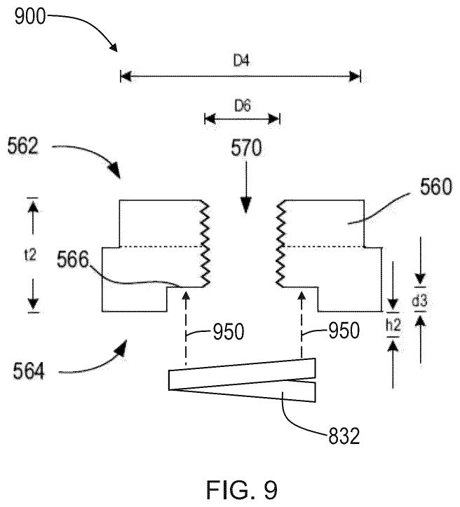

Referring to FIG. 9, in an embodiment a self-locking nut 900 includes the fastener or nut body 560 including the circular recess 566 and the threaded through-hole 570, and also includes the separate compressible helical extrusion 832 in the form of a circular locking mechanism 832. The circular locking mechanism 832 is engineered to precisely fit within the circular recess 566, as indicated by dashed arrows 950. The shape of the cross-section of the circular locking mechanism 832 may vary at one or more points along the spiral. For instance, the cross-section of the circular locking mechanism 832 may have a shape that is rectangular, square, circular, oval, irregular, and so forth, and any combination thereof. In some embodiments, at least a portion of the circular locking mechanism 832 may include a pebbled finish, a burred finish, a textured finish, a smooth finish, and so forth, or a combination thereof.

When compressed (e.g., due to the self-locking fastener 800, the self-locking nut 900, or both, being bolted or screwed into place), frictional resistance between the circular locking mechanism 832 and the receiving surface prevents the self-locking fastener 800, the self-locking nut 900, or both from loosening due to vibrations or other mechanical movement, as described. As with an integrated locking mechanism, once in place, the separate circular locking mechanism 832 may be completely hidden, protected and constrained.

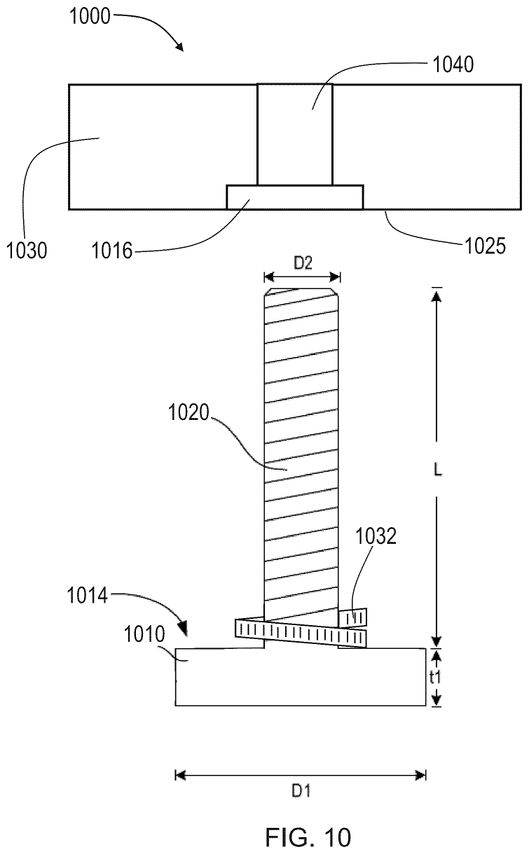

Referring to FIG. 10, another embodiment of a self-locking fastener 1000, includes a circular recess 1016 like the circular recesses 116, 566 described above as being within the fastener body 110 or the nut body 560, respectively. However, in this embodiment, as shown in FIG. 10, the circular recess 1016 is positioned within a surface 1025 of material 1030 being fastened by the fastener body 1010. The circular recess 1016 can be centered on a bore 1040 sized and tapped to accept the threaded rod 1020. The circular recess 1016 is sized to allow a compressible helical extrusion 1032 to be compressed into the circular recess 1016 until the fastener body 1010 is appropriately torqued against the adjacent surface 1025 of the material 1030 being fastened. In some implementations, the compressible helical extrusion 1032 is connected to and extends from a side 1014 of the fastener body 1010 and extends around the threaded rod 1020. In some implementations, the compressible helical extrusion 1032 can be a separate compressible helical locking mechanism, for example without limitation, a traditional lock washer or a compression spring or of a hybrid of the two, which is engineered to precisely fit within the circular recess 1016.

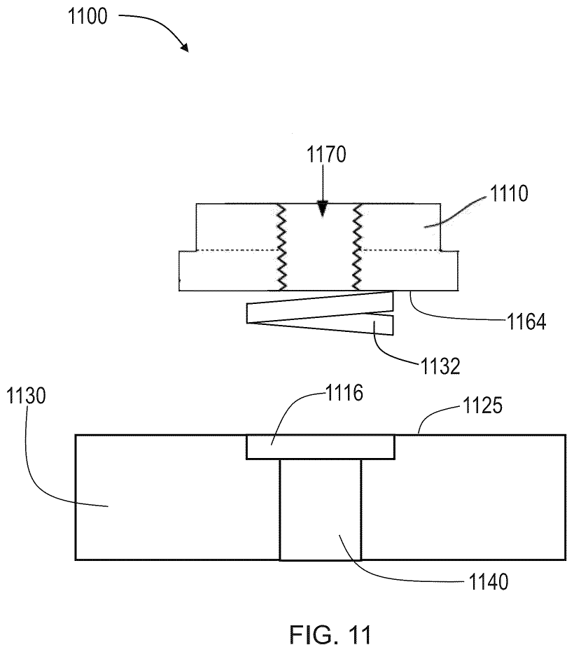

Referring to FIG. 11, another embodiment of a self-locking fastener 1100, includes a circular recess 1116 like the circular recesses 116, 566 described above as being within the fastener body 110 or the nut body 560, respectively. However, in this embodiment, as shown in FIG. 11, the circular recess 1116 is positioned within a surface 1125 of material 1130 being fastened by the fastener body 1110. The circular recess 1116 can be centered on a bore 1140 sized and tapped to accept threads of a fastener, for example, a bolt. The circular recess 1116 is sized to allow a compressible helical extrusion 1132 to be compressed into the circular recess 1116 until the fastener body 1110 is appropriately torqued against the adjacent surface 1125 of the material 1130 being fastened. In some implementations, the compressible helical extrusion 1132 is connected to and extends from a side 1164 of the fastener body 1110 and extends around a threaded bore 1170 through the fastener body 1110. In some implementations, the compressible helical extrusion 1132 can be a separate compressible helical locking mechanism, for example without limitation, a traditional lock washer or a compression spring or of a hybrid of the two, which is engineered to precisely fit within the circular recess 1116.

In some embodiments, any of the above-described self-locking fasteners 100, 400, 800, 1000 and/or self-locking nuts 550, 900, 1100 can be manufactured by machining from a starting work piece, or by using additive technologies (e.g., 3D printing). Such manufacturing may be desirable in some applications in which it may be necessary or advantageous to create a self-locking fastener 100, 400, 800, 1000 a self-locking nut 550, 900, 1100 or both, using materials optimized for compatibility with the material being fastened. For example, it may be advantageous to produce a self-locking fastener 100, 400, 800, 1000 and/or self-locking nut 550, 900, 1100 or a component thereof, using carbon fiber material or carbon fiber composite, or organic material.

For instance, in some applications, a self-locking fastener 100, 400, 800, 1000 and/or self-locking nut 550, 900, 1100 made using carbon fiber material or carbon fiber composite, as described, may be used to help strengthen or secure carbon fiber layers or panels. Such self-locking fastener 100, 400, 800, 1000 and/or self-locking nut 550, 900, 1100 may provide superior performance over conventional fasteners made from, for example, stainless steel, which may be more prone to cutting or tearing through the layers or panels, especially when subject to significant vibration. Also, a self-locking fastener 100, 400, 800, 1000 and/or self-locking nut 550, 900, 1100 as described, made using an organic material may be advantageous in some medical applications (e.g., orthopedic applications), which can require materials to be accepted and integrated into, for example, a bone or bony structure (e.g., skull) of a person.

Furthermore, the above-described self-locking fastener 100, 400, 800, 1000 and/or self-locking nut 550, 900, 1100 may allow for respective fastening properties to be easily tailored for a variety of intended uses. For example, the amount of resistance generated by any of the compressible helical extrusions 132, 582, 832, 1032, 1132 as described herein, can be easily changed, for instance, by modifying pitch, thickness, cross-section, material, or a combination thereof. For some applications, resistance to loosening can be enhanced by, in the case of a lock washer type of any of the compressible helical extrusions 132, 582, 832, 1032, 1132 including a pebbled, textured, or burred finish to a bottom surface of the compressible helical extrusion 132, 582, 832, 1032, 1132 as described.

The present disclosure is described with reference to the attached figures, where like reference numerals are used throughout the figures to designate similar or equivalent elements. The figures are not drawn to scale, and are provided merely to illustrate the instant disclosure. Several aspects of the disclosure are described below with reference to example applications for illustration. It should be understood that numerous specific details, relationships, and methods are set forth to provide a full understanding of the disclosure. One having ordinary skill in the relevant art, however, will readily recognize that the disclosure can be practiced without one or more of the specific details, or with other methods. In other instances, well-known structures or operations are not shown in detail to avoid obscuring the disclosure. The present disclosure is not limited by the illustrated ordering of acts or events, as some acts may occur in different orders and/or concurrently with other acts or events. Furthermore, not all illustrated acts or events are required to implement a methodology in accordance with the present disclosure.

One or more elements or aspects or steps, or any portion(s) thereof, from one or more of any of claims 1-18 below can be combined with one or more elements or aspects or steps, or any portion(s) thereof, from one or more of any of the other claims 1-18 or combinations thereof, to form one or more additional implementations and/or claims of the present disclosure.

While various examples of the present disclosure have been described above, it may be understood that they have been presented by way of example only, and not limitation. Numerous changes to the disclosed examples can be made in accordance with the disclosure herein without departing from the spirit or scope of the disclosure. Thus, the breadth and scope of the present disclosure should not be limited by any of the above-described examples. Rather, the scope of the disclosure should be defined in accordance with the following claims and their equivalents.

Although the disclosure has been illustrated and described with respect to one or more implementations, equivalent alterations and modifications will occur to others skilled in the art upon the reading and understanding of this specification and the annexed drawings. In addition, while a particular feature of the disclosure may have been disclosed with respect to only one of several implementations, such feature may be combined with one or more other features of the other implementations as may be desired and advantageous for any given or particular application.

The terminology used herein is for the purpose of describing particular examples only and is not intended to be limiting of the disclosure. As used herein, the singular forms “a,” “an,” and “the” are intended to include the plural forms as well, unless the context clearly indicates otherwise. Furthermore, to the extent that the terms “including,” “includes,” “having,” “has,” “with,” or variants thereof, are used in either the detailed description and/or the claims, such terms are intended to be inclusive in a manner similar to the term “comprising.”

Unless otherwise defined, all terms (including technical and scientific terms) used herein have the same meaning as commonly understood by one of ordinary skill in the art to which this disclosure belongs. Furthermore, terms, such as those defined in commonly used dictionaries, should be interpreted as having a meaning that is consistent with their meaning in the context of the relevant art, and will not be interpreted in an idealized or overly formal sense unless expressly so defined herein.

What is claimed is:

1. A self-locking fastener comprising:
a fastener head comprising a first side and a second side;
a threaded rod that extends from the second side of the fastener head;
a circular recess formed in a surface of the second side of the fastener head; and
a compressible helical extrusion adapted to be positioned within the circular recess and spiral around the threaded rod, wherein at least a portion of the compressible helical extrusion spirals outwardly beyond the surface of the second side of the fastener head.

2. The self-locking fastener of claim 1, wherein the compressible helical extrusion is connected to the circular recess.

3. The self-locking fastener of claim 1, wherein a cross-section of the compressible helical extrusion is rectangular, square, circular, or oval.

4. The self-locking fastener of claim 1, wherein a center of the circular recess corresponds to the center of the threaded rod, and wherein an outer diameter of a spiral formed by the compressible helical extrusion is less than a diameter of the circular recess of the fastener head.

5. The self-locking fastener of claim 1, wherein at least a portion of the compressible helical extrusion comprises a pebbled finish, or a burred finish.

6. The self-locking fastener of claim 1, wherein the fastener head and the compressible helical extrusion are formed using a carbon fiber material or an organic material.

7. The self-locking fastener of claim 1, wherein a force applied to the compressible helical extrusion transforms the compressible helical extrusion into a compressed state in which the compressible helical extrusion fits entirely inside the circular recess.

8. The self-locking fastener of claim 1, wherein the self-locking fastener further comprises a seal recess formed in a surface of the second side of the fastener head, the seal recess configured to receive a seal ring.

9. The self-locking fastener of claim 1, wherein the self-locking fastener comprises a screw, a bolt, an anchor, a knob, or a plug.

10. A self-locking nut comprising:
a nut body comprising a first side and a second side;
a threaded through-hole that extends from the first side of the nut body;
a circular recess formed in a surface of the second side of the nut body; and
a compressible helical extrusion adapted to be positioned within the circular recess, wherein at least a portion of the compressible helical extrusion spirals outwardly beyond the surface of the second side of the nut body.

11. The self-locking nut of claim 10, wherein the compressible helical extrusion is connected to the circular recess.

12. The self-locking nut of claim 10, wherein a cross-section of the compressible helical extrusion is rectangular, square, circular, or oval.

13. The self-locking nut of claim 10, wherein a center of the circular recess corresponds to the center of the threaded through-hole, and wherein an outer diameter of a spiral formed by the compressible helical extrusion is less than a diameter of the circular recess of the nut body.

14. The self-locking nut of claim 10, wherein at least a portion of the compressible helical extrusion comprises a pebbled finish, or a burred finish.

15. The self-locking nut of claim 10, wherein the nut body and the compressible helical extrusion are formed using a carbon fiber material or an organic material.

16. The self-locking nut of claim 10, wherein a force applied to the compressible helical extrusion compacts the compressible helical extrusion into the circular recess.

17. The self-locking nut of claim 10, wherein the self-locking nut further comprises a seal recess formed in a surface of the second side of the fastener head, the seal recess configured to receive a seal ring.

18. The self-locking nut of claim 10, wherein the self-locking nut comprises a hex nut, a jam nut, a castle nut, a square nut, a cap nut, a slotted nut, a flanged nut, a wing nut, a coupling, or a knob.

19. A self-locking fastener comprising:
a fastener body comprising a first side and a second side;
a threaded region that extends from the second side of the fastener body or through the fastener body;
a circular recess formed in a surface of the second side of the fastener body; and
a compressible helical extrusion adapted to be positioned within the circular recess, wherein an inner diameter of the compressible helical extrusion is greater than a diameter of the threaded region, and wherein at least a portion of the compressible helical extrusion spirals outwardly beyond the surface of the second side of the fastener body.

20. The self-locking fastener of claim 19, wherein the compressible helical extrusion is connected to the circular recess of the fastener body.
